(19) United States
(12) Patent Application Publication
(10) Pub. No.: US 2002/0015607 A1
(43) Pub. Date: Feb. 7, 2002

(54) Ink cartridge

(75) Inventor: Robert M. Matich, Colorado Springs, CO (US)

Correspondence Address: WIGGIN & DANA LLP, ATTENTION: PATENT DOCKETING, ONE CENTURY TOWER, P.O. BOX 1832, NEW HAVEN, CT, 06508-1832, US

(73) Assignee: Hunt Imaging LLC

(21) Appl. No.: 09/911,146

(22) Filed: Jul. 23, 2001

Related U.S. Application Data
(60) Provisional application No. 60/221,529, filed on Jul. 28, 2000.

(51) Int. Cl. B41J 31/00

(52) U.S. Cl. 400/191

(57) ABSTRACT

? An ink cartridge includes a molded body defining a cavity extending between closed and open ends and having a port surrounded by a threaded fitting. The piston is slideable between first and second positions within the body while maintaining a seal with the body. A charge of ink is located within the body between the closed end and a piston underside. The body may advantageously be formed having a transverse section which is a rounded rectangle. An axis of the port is advantageously orthogonal to an axis of the body. The axis of the body is advantageously vertical.

### CROSS-REFERENCE TO RELATED APPLICATION

This patent application claims priority of U.S. Provisional Patent Application Serial No. 60/221,529 entitled “Ink Cartridge” that was filed on Jul. 28, 2000, the disclosure of which is incorporated by reference in its entirety herein.

### BACKGROUND OF THE INVENTION

?(1) Field of the Invention

This invention relates to ink cartridges for printing devices, and more particularly to ink cartridges for digital duplicators.

?(2) Description of the Related Art

Laser printers and copiers are ubiquitous in the modem office environment. When utilized as printer or copier, digital duplicators have distinct cost advantages over their laser counterparts. A digital duplicator automatically creates a master stencil sheet for each page to be printed. The images to be printed on each page are formed as pores in the associated master via a thermal head or other means. The master is applied to a drum and inked, with the ink becoming captured by the pores. The paper or other print medium is contacted by the inked master to transfer the image to the paper. A given master can generate many copies and provide significant cost efficiencies in high volume use.

To provide an appropriately sized ink reservoir, digital duplicators typically feature replaceable ink cartridges having capacities in the vicinity of 0.6-1.0 liter, with 0.6 liter being a particularly common size.

There are a number of well known brands and manufacturers of digital duplicators. These include: the PRIPORT series by Ricoh Company, LTD, Tokyo; the RISOGRAPH series by Riso Kagaku Corporation, Tokyo; and the DUPLO series by Duplo Corporation, Tokyo. Different duplicators frequently have different cartridge interfaces (i.e., the size and shape of the compartment available for the cartridge and the configuration and location of the fitting(s) interfacing with such cartridges). In additional to the original equipment manufacturers (OEM) which manufacture cartridges in a variety of forms, there are a number of replacement cartridge manufacturers offering cartridges which are drop-in replacements for the OEM cartridges although not necessarily identically constructed. Thus, there are a variety of cartridge constructions on the market.

Key forms of cartridge are the bag-in-box type. These typically feature a non-corrugated cardboard (paperboard) box of appropriate dimensions for the associated duplicator. Contained within the box is a flexible plastic bladder containing the ink. An outlet fitting (typically threaded) is integrally formed with the bladder and extends through an aperture in the box at the appropriate location to mate with the associated fitting of the machine. In operation, a pump within the machine draws the ink through the outlet fitting, contracting the bladder within the box. Among other bladder variations is that shown in U.S. Pat. No. 4,961,518 of Shoji et al. which shows a half-rigid, half-flexible container with a diagonal border between the two. In other containers, the border between rigid and flexible portions is vertical.

Some duplicators utilize tubular containers which include moveable pistons. One example is shown in U.S. Pat. No. 5,373,969 of Takemura assigned to Riso Kagaku Corporation. Also, Hunt Imaging, LLC, of Berea, Ohio manufactures a series of tubular cartridges compatible with Risograph duplicators.

### BRIEF SUMMARY OF THE INVENTION

I have noticed a number of potential drawbacks in the use of various existing containers, namely in the filling, discharge and disposal thereof. Bag-in-box cartridges can require the use of a pump to evacuate the bag as best possible prior to its filling. This can impose a variety of manufacturing constraints including additional costs. During discharge, as the bag contracts, a number of often related problems can occur. Uneven contraction can cause variations in the ease of withdrawing ink. Additionally, where residual or other air is present in the bag, uneven contraction can cause such air to be drawn into the duplicator prior to the anticipated depletion of the cartridge. Potentially significant volumes of ink may be left in the cartridge at its depletion, especially where a cartridge is configured to avoid problems of uneven withdrawal. Finally, bag-in-box constructions can present a number of recycling problems. The presence of both fibrous (cardboard) and plastic materials increases recovery costs as does the presence of dissimilar plastic materials such as a rigid outlet fitting (e.g., polypropylene or polyethylene) integrated with a flexible bladder (e.g., polypropylene or a poly-extruded film).

Accordingly, in one aspect the invention is directed to an ink cartridge. The cartridge has a body having a bottom wall and a sidewall extending from the bottom wall to a rim and having inner and outer surfaces. At least one leg depends from the bottom wall and has dimensions effective to support the bottom wall spaced apart from a horizontal support surface of the duplicator into which the cartridge is installed. A port is circumscribed by a fitting and has a port axis extending generally horizontally. A piston has a lateral surface of complementary form to the sidewall inner surface so as to be slideable between first and second positions within the body while maintaining a seal with the body.

In various implementations, the cartridge may contain a charge of ink within the body between the bottom wall and an underside of the piston and may have a volume between 0.2 and 1.2 liters. The ink may be a water in oil reverse emulsion paste ink. The body may comprise polypropylene (e.g., talc filled polypropylene). A cap (e.g., a threaded cap) may be secured on the fitting. A cover, strap, or other bridging member may have first and second end portions gripping the sidewall at the rim and extending across at least part of the otherwise open end of the body at the rim. The bottom wall may have an open channel extending to the port.

In another aspect the invention is directed to an ink cartridge having a molded body defining a cavity extending from a substantially closed lower end to a substantially open upper end and having a port surrounded by a fitting with a port axis extending generally horizontally. A piston is slideable between first and second positions within the body while maintaining a seal with the body. A charge of ink is located within the body between the lower end and an underside of the piston. It has a volume of between 0.2 and 1.2 liters. The body may include at least one (e.g., exactly two) support legs extending from the cavity lower end to support the cavity spaced apart above a horizontal support surface.

In another aspect, the invention is directed to an ink cartridge having a molded body. The body has first and second ends. An end wall at the first end has inner and outer surfaces. A sidewall extending from the end wall to the second end has an inner surface having a section formed as a rectangle with rounded comers. There is an integral port. A piston has a lateral surface of complementary form to the sidewall inner surface so as to be slideable between first and second positions within the body while maintaining a seal with the body.

In various implementations of the invention, the section may have two long sides and two short sides. The cartridge may further include a bridging member having first and second end portions gripping a rim of the body at the opened end and spanning the open end. There may be no individual cardboard package associated with the cartridge.

In another aspect, the invention is directed to a method for assembling an ink cartridge. A molded body is provided having first and second ends and an integral port. A piston is provided having an external surface of complementary shape to an internal lateral surface of the body. The piston is inserted through the body second end and delivered to a first location proximate the body first end. Ink is introduced to the body through the port to fill the body and drive the piston toward the body second end. At least partially during the introduction, a biasing member is maintained in contact with the back surface of the piston so as to maintain alignment of the piston.

In various implementation, the biasing member may be maintained with sufficient orientational stability to counter an upsetting torque applied to the piston via off-center introduction of the ink. A bridging member may be secured across the body second end and the port may be sealed such as by screwing a threaded cap onto a threaded fitting of the body.

In another aspect, the invention is directed to a method for remanufacturing an ink cartridge. An expended cartridge is provided. Ink is introduced to the cartridge body through a port to fill the body and drive a piston from a first location proximate a body first end toward a body second end. At least partially during the introduction, a biasing member is maintained in contact with a back surface of the piston so as to maintain alignment of the piston.

In another aspect, the present invention is directed to an ink cartridge which includes a molded body defining a cavity extending between closed and open ends and having a port surrounded by a threaded fitting. The piston is slideable between first and second positions within the body while maintaining a seal with the body. A charge of ink is located within the body between the closed end and a piston underside. The body may advantageously be formed having a transverse section which is a rounded rectangle. An axis of the port is advantageously orthogonal to an axis of the body. The axis of the body is advantageously vertical.

Among potential advantages of the invention is that a drop-in-replacement for a bag-in-box cartridge can be provided. Reduced use of dissimilar materials can improve recyclability. Improvements in the extraction of ink may also be had. Additionally, use of a piston can provide the user with enhanced visualization of the usable amount of ink remaining in the cartridge. Such advantages are not limiting and no such advantage is necessarily present in any particular embodiment.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a cut-away front view of an ink cartridge according to principles of the invention in a substantially full condition.

FIG. 2 is a cross-sectional view of the ink cartridge of FIG. 1 in a substantially empty condition.

FIG. 3 is a top view of the cartridge of FIG. 1.

FIG. 4 is a top view of a body of the cartridge of FIG. 1.

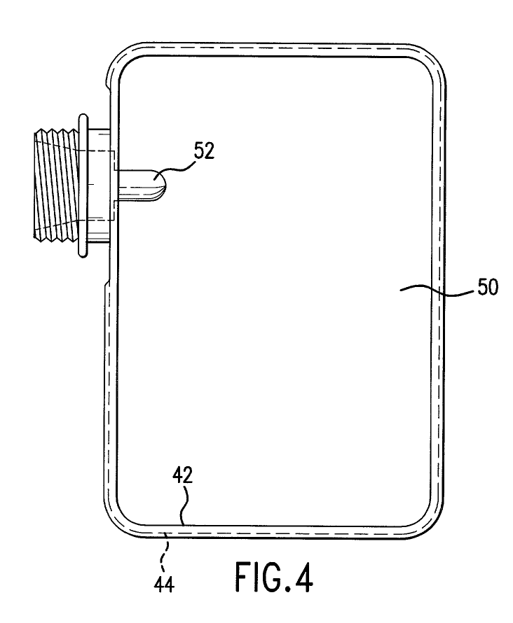

FIG. 5 is a view of the underside of a cover of the cartridge of FIG. 1.

FIG. 6 is a cut-away view of the body and piston of the cartridge of FIG. 1 during filling.

FIG. 7 is a cross-sectional view of the cartridge of FIG. 1 during an initial filling condition.

FIG. 8 is a cross-sectional view of the cartridge of FIG. 1 during a subsequent filling condition.

Like reference numbers and designations in the various drawings indicate like elements.

### DETAILED DESCRIPTION

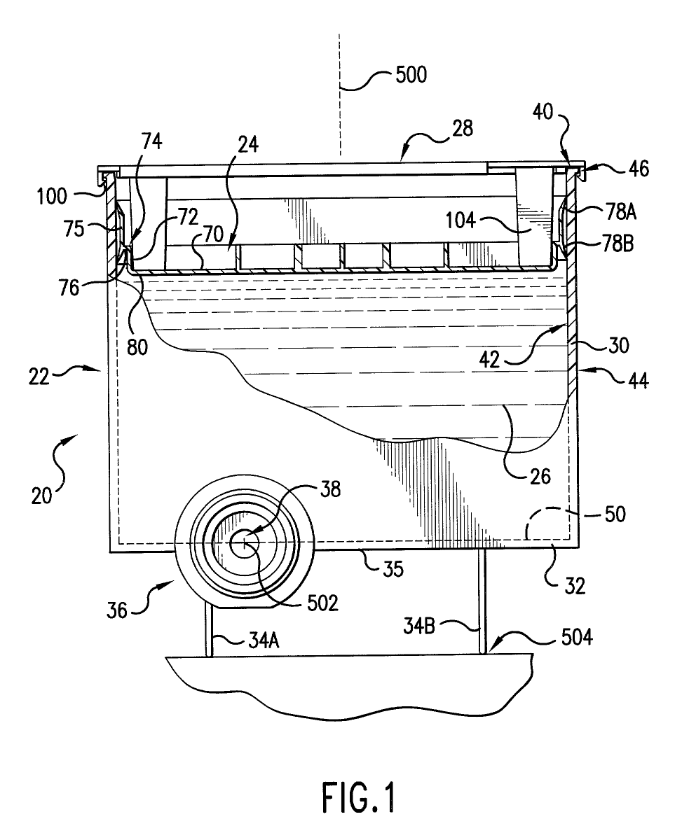

FIG. 1 shows a cartridge 20 having a body 22, a piston 24, slidably mounted within the body, a charge of ink 26 contained within the body below the piston, and a cap or cover 28 spanning the top of the body. The exemplary cartridge is configured for use with a particular DUPLO duplicator and is considered illustrative.

The body comprises a unitary molding of: a lateral sidewall 30; a bottom wall 32, the perimeter of which merges with the sidewall lower end; a pair of legs 34A and 34B depending from the underside (bottom surface) 35 of the bottom wall; and a fitting 36 surrounding a port 38.

The sidewall includes a rim 40 at its open upper end and has interior (inner) and exterior (outer) surfaces 42 and 44 with a thickness therebetween. In transverse section (e.g., perpendicular to a central vertical axis 500), the inner and outer surfaces are formed as rectangles having rounded corners. Along a major central portion of the vertical extent of the sidewall, the inner surface is very close to vertical. However, ease of manufacturing might provide this surface portion with a very slight top-to-bottom taper. An upper portion adjacent the rim 40 may flare outward, be beveled, or have other features for guiding insertion of the piston (discussed below). The rim 40 may include an outwardly-directed lip 46 (also discussed below).

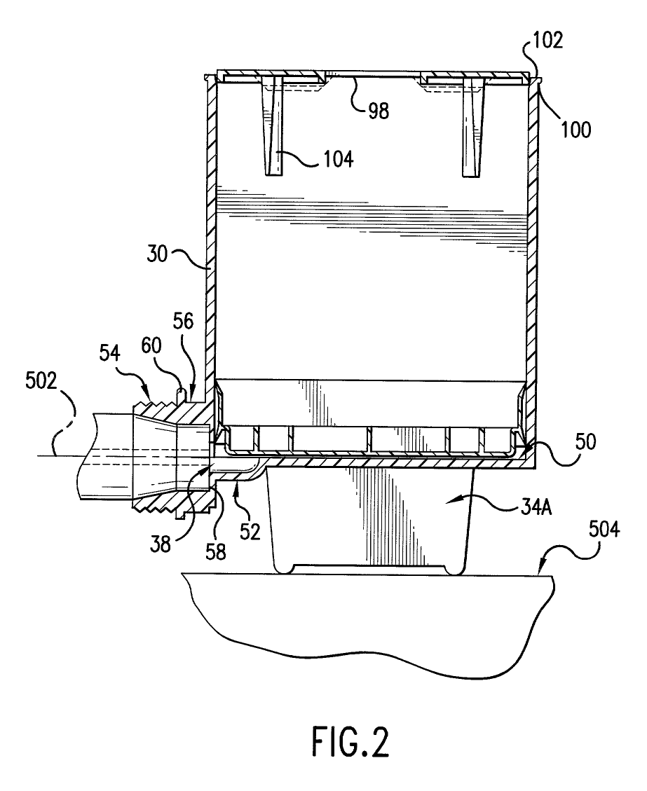

The upper (interior/inner) surface 50 of the bottom wall 32 is advantageously substantially flat, subject to the inclusion of a channel 52 (FIG. 2) aligned with and leading to the port 38. The channel is formed as a depression in the bottom wall extending for a short distance (e.g., a couple of port diameters) inward from the port 38. In the exemplary embodiment, this permits the port/fitting axis 502 to be approximately coplanar with the bottom wall upper surface 50 beyond the channel 52.

The fitting 36 is formed as a cylindrical tube having a threaded distal portion 54 and a proximal portion 56 which, along an upper portion thereof, merges with the body sidewall 30. A lower portion of the fitting proximal portion depends below the body sidewall and bottom wall and is closed by an annular sector 58 depending below the sidewall and joining with the channel. A flange 60 separates fitting distal and proximal portions. An internal surface of the fitting may be contoured to mate with a probe of the duplicator interface to withdraw ink from the cartridge.

The legs 34A and 34B are formed as flat plates of slightly trapezoidal configuration having a height effective to space the bottom wall underside 35 apart from a horizontal support surface 504 by a corresponding amount effective to align the fitting with mating features of a particular duplicator.

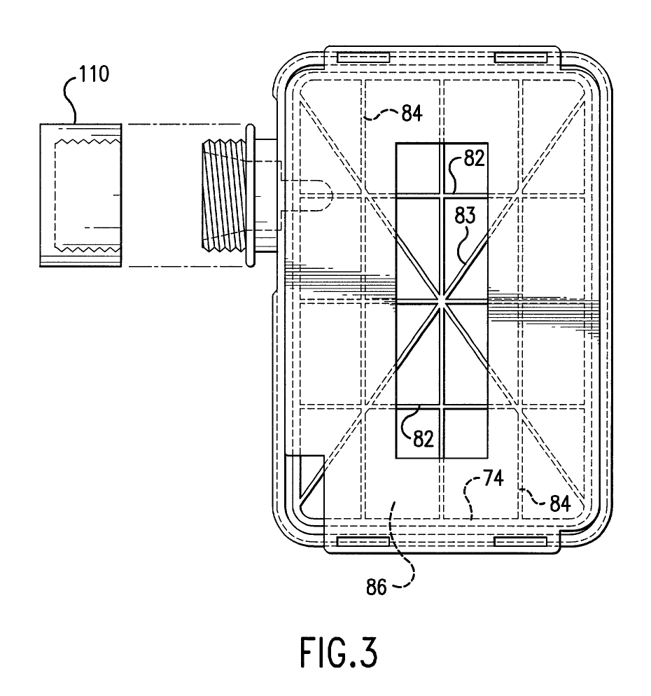

The piston 24 (FIG. 1) is also advantageously unitarily formed as a one-piece molding. The piston has a flat bottom wall 70, from the perimeter of which a short sidewall 72 extends upward to a rim 74. The rim is just inside of a central vertical band 75 of a sealing ring portion of the piston and connected thereto via a short web 76. On upper and lower extremities of the band, outwardly-flared lips 78A and 78B extend upward and downward, respectively. A lower rim of the lower lip is advantageously located above the underside 80 of the piston bottom wall 70. The outward flaring and tapering construction of the lips provides them with flexibility to seal with the body sidewall inner surface. Such flexibility is sufficient to accommodate the slight taper of that surface. Longitudinal, diagonal, and transverse reinforcing ribs 82, 83, and 84 (FIG. 3) extend upward from the upper surface 86 of the piston bottom wall to a height approximately coextensive with the rim 74 of the sidewall 72.

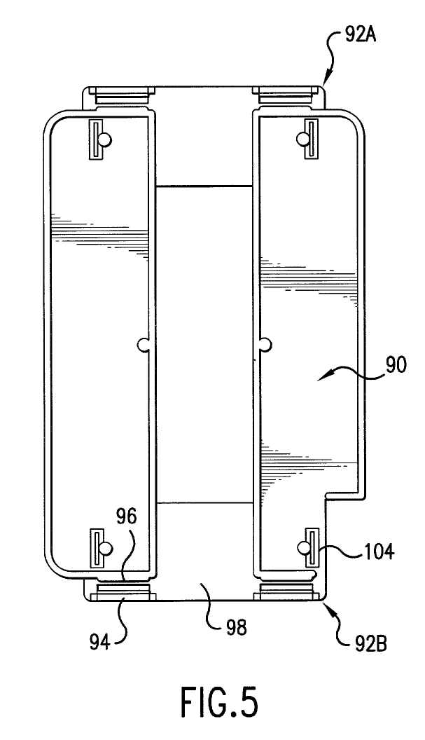

The cover 28 (FIG. 5) is also advantageously unitarily formed as a one-piece molding. The cover is formed having a centrally-apertured web 90 extending between gripping portions 92A and 92B at opposite ends of the cover. Each gripping portion includes an outboard wall 94 and an inboard wall 96 depending from an underside 98 of the web 90. The associated inboard and outboard walls are spaced apart from each other slightly. The inboard surface of the outboard wall is provided with a projection 100 (FIG. 2). The underside 98 may be provided with slight reinforcing ribs for improved structural integrity at reduced weight. In its installed condition, the cover is retained on the body via cooperation of the projections 100 with the outwardly-directed lip 46 at the body sidewall rim at opposite ends thereof. Viewed from above, the cover is formed generally as a rectangle and thus extends at least partially diagonally across the open upper end of the body (e.g., across the entire span orthogonal to the axis 502). Grasping of the ends of the sidewall rim is advantageous because in a preferred molding operation a mold element defining the upper half of the fitting translates vertically during assembly and disassembly. This translation is facilitated via a corresponding interruption in the lip 46. Additionally, a number of legs 104 may depend from the underside of the cover. The ends of the legs are positioned to engage or be slightly spaced apart from the piston when the cartridge is full. Engagement between the legs and the piston can thus maintain the position or orientation of the piston during shipping.

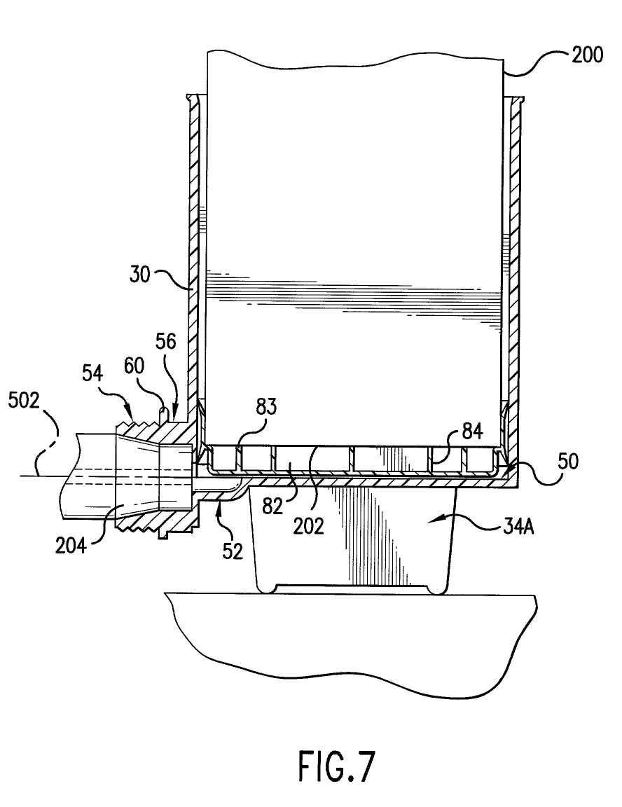

To assemble the cartridge, the piston is advantageously inserted into the body through the open end and fully depressed so that the piston underside bottoms out against the bottom wall upper surface. An ink supply may then be connected to the fitting (e.g., via a probe 204 (FIG. 7)). The supply may be of any appropriate digital duplicator ink (e.g., a water in oil reverse emulsion paste ink).

The non-circular body inner surface may be associated with less stability of the piston against rotations orthogonal to its axial direction as compared with the prior art Hunt Imaging cartridge. The elongate nature of the prior art cartridge facilitates provision of a longer, more stable piston since a length increase can be associated with a proportionately smaller decrease in capacity. When these are combined with the non-axial, off-center, introduction of a viscous ink, off-center contact of the ink with the piston underside can produce a torque on the piston which may be effective to disturb the piston's orientation. An assembler may use his or her hand to steady the piston as ink is introduced through the port. As the cartridge is being filled, the assembler may gently squeeze the sidewall into a more out-of-rectangular section to create one or more gaps between the sidewall and piston to permit the escape of trapped air around the piston.

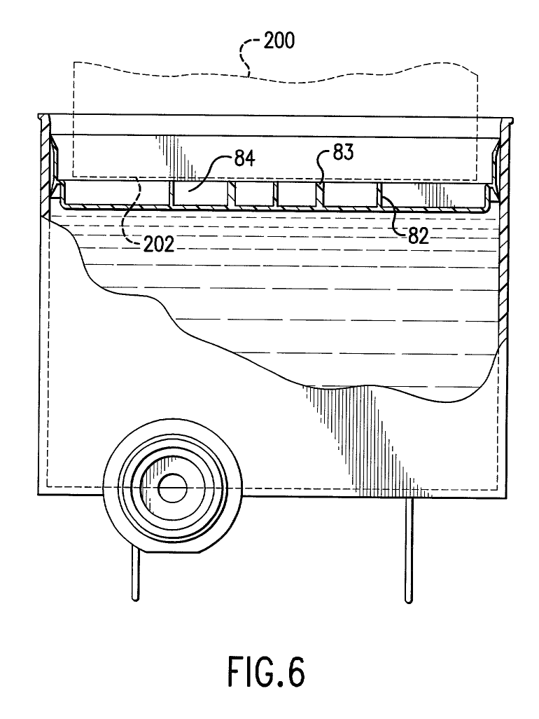

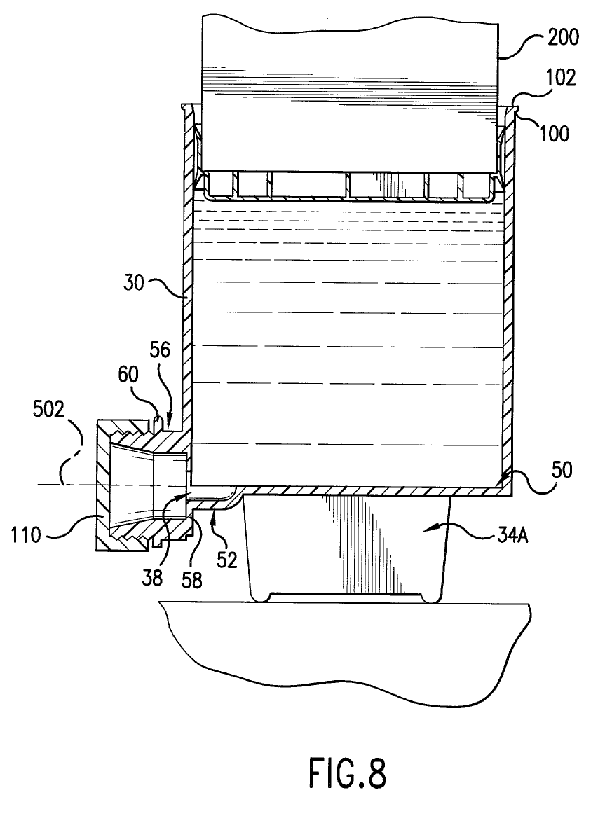

Optionally, prior to filling of the cartridge, a fixture 200 (FIGS. 6 and 7) may be inserted into the body so that its underside 202 contacts the reinforcing ribs 82-84 of the piston. The fixture may also have been utilized to drive the piston to the bottomed position or may be inserted after the piston is already bottomed. The fixture may be hand-held, weighted, spring-loaded, pneumatically or otherwise actuated or any appropriate combination effective to apply a downward force on the piston while maintaining the orientation of the fixture. Thereby the fixture maintains the orientation of the piston as ink is introduced through the port to raise the piston to a full level (FIG. 8) proximate the upper end of the body.

When the cartridge is full, the fixture (if any) may be disengaged from the piston, and the supply disengaged from the fitting. A threaded cap 110 may be screwed onto the fitting to seal the ink within the body. The cover may then be snap fit into engagement with the upper end of the body. The cover aperture may provide a handle permitting a user to easily install and remove the cartridge from a duplicator.

Advantageously, graphics and text may be applied to the body via labels, decals, paint, and/or other appropriate means. Advantageously, no additional individual packaging needs to be supplied for the cartridge, although shrink wrap, a bag, or even a box may be supplied. For shipping, multiple individual cartridges may be packaged in a single carton. For example, 6-12 cartridges may advantageously be packed in a single carton. One example involves six cartridges in two rows of three, the fittings of each cartridge facing an associated cartridge in the opposite row to provide space efficiency via nesting. Multiple tiers of cartridges may be included in the carton and a cardboard or other rigid divider between each tier may be advantageously provided. Preferred material for the piston and strap is polypropylene, while preferred material for the cartridge body is 40% talc-filled polypropylene.

After the cartridge has been expended, it may be removed and recycled, either via reconstruction and reuse or by post-consumer retrieval of the component materials. If the former, the cartridge is disassembled into its individual components and cleaned and inspected. The individual components may be reassembled or reused with new components as might be the case if the piston were worn while the body is undamaged. If the latter, it may be particularly advantageous that each component is formed of a single material or that all components are formed either of the same material or a material which may be commonly recycled.

One or more embodiments of the present invention have been described. Nevertheless, it will be understood that various modifications may be made without departing from the spirit and scope of the invention. For example, the desired interface will influence a number of configuration details. This may include a variety of fitting configurations and locations, a variety of body cross-sections and even body orientations (e.g., horizontal piston movement). Accordingly, other embodiments are within the scope of the following claims.

What is claimed is:

1. An ink cartridge comprising:
a body comprising:
a bottom wall;
a sidewall extending from the bottom wall to a rim and having inner and outer surfaces;
at least one leg depending from the bottom wall and having dimensions effective to support the bottom wall spaced apart from a horizontal support surface of a duplicator into which the cartridge is installed;
a port, circumscribed by a fitting having a port axis extending generally horizontally; and
a piston having a lateral surface of complementary form to the sidewall inner surface so as to be slideable between first and second positions within the body while maintaining a seal with the body.

2. The cartridge of claim 1 further comprising:
a charge of ink within the body between the bottom wall and an underside of the piston and having a volume between 0.2 and 1.2 liters; and
a cap on the fitting.

3. The cartridge of claim 2 wherein the ink is a water in oil reverse emulsion paste ink.

4. The cartridge of claim 1 wherein the body comprises polypropylene.

5. The cartridge of claim 4 wherein the polypropylene is talc-filled.

6. The cartridge of claim 1 further comprising a protective member gripping the sidewall at the rim and at least partially covering an open end of the body at the rim.

7. The cartridge of claim 6 wherein the protective member comprises a plurality of feet protruding toward the piston so as to block upward movement of the piston above a particular height within the body.

8. The cartridge of claim 1 wherein the bottom wall has an open channel extending to the port.

9. An ink cartridge comprising:
a molded body defining a cavity extending from a substantially closed lower end to a substantially open upper end and having a port surrounded by a fitting and having a port axis extending generally horizontally;
a piston slideable between first and second positions within the body while maintaining a seal with the body; and
a charge of ink within the body between the lower end and an underside of the piston and having a volume between 0.2 and 1.2 liters.

10. The cartridge of claim 9 wherein the ink is a reverse emulsion ink.

11. The cartridge of claim 9 wherein the molded body further includes at least one support leg extending from the cavity lower end to support the cavity spaced apart above a horizontal support surface.

12. The cartridge of claim 9 wherein the molded body further includes exactly two support legs formed as plates and extending from the cavity lower end to support the cavity spaced apart above a horizontal support surface.

13. An ink cartridge comprising:
a molded body having:
first and second ends;
an end wall at the first end and having inner and outer surfaces;
a sidewall extending from the end wall to the second end, the sidewall having an inner surface having a section formed as a rectangle with rounded corners; and
an integral port;
a piston having a lateral surface of complementary form to the sidewall inner surface so as to be slideable between first and second positions within the body while maintaining a seal with the body.

14. The cartridge of claim 13 wherein the port comprises a threaded fitting and the end wall inner surface includes an open channel extending toward the port.

15. The catridge of claim 14 wherein:
the molded body includes at least one leg depending from the end wall outer surface and having dimensions effective to support the end wall spaced apart from a horizontal support surface of a duplicator into which the cartridge is installed.

16. The cartridge of claim 15 comprising two such legs, each formed as an elongate plate oriented parallel to an axis of the fitting, and wherein the axis extends horizontally when the cartridge is so installed.

17. The cartridge of claim 15 wherein the section has two long sides and two short sides and wherein the cartridge further comprises a protective member gripping the sidewall at a rim of the body.

18. The cartridge of claim 15 wherein there is no individual cardboard package associated with the cartridge.

19. A method for assembling an ink cartridge comprising:
providing a molded body having a first end and a second end and an integral port;
providing a piston having an external lateral surface of complementary shape to an internal lateral surface of the body;
inserting the piston through the body second end and delivering the piston to a first location proximate the body first end;
introducing ink to the body through the body port to fill the body and drive the piston toward the body second end; and
at least partially during said introduction maintaining a biasing member in contact with a back surface of the piston, to maintain alignment of the piston.

20. The method of claim 19 wherein the biasing member is maintained with sufficient orientational stability to counter an upsetting torque applied to the piston via off-center introduction of the ink.

21. The method of claim 19 further comprising:
securing a bridging member across the body second end; and
sealing the port.

22. The method of claim 21 wherein:
said sealing the port comprises screwing a threaded cap onto a threaded fitting of the body.

23. A method for remanufacturing an ink cartridge comprising:
providing an expended cartridge comprising:
a molded body having a first end and a second end and an integral port;
a piston having an external lateral surface of complementary shape to an internal lateral surface of the body;
introducing ink to the body through the body port to fill the body and drive the piston from a first location proximate the body first end toward the body second end; and
at least partially during said introduction maintaining a biasing member in contact with a back surface of the piston, to maintain alignment of the piston.

24. The method of claim 23 further comprising:
removing a bridging member from the body second end prior to the introduction; and
resecuring the bridging member or securing another bridging member across the body second end after the introduction.
